(19) United States
(12) Patent Application Publication
(10) Pub. No.: US 2004/0235367 A1
(43) Pub. Date: Nov. 25, 2004

(54) Flush mounted conversational terminal

(75) Inventor: Hugues Da Dalt, Champniers (FR)

Correspondence Address: PARKHURST & WENDEL, L.L.P., 1421 PRINCE STREET, SUITE 210, ALEXANDRIA, VA, 22314-2805, US

(73) Assignee: Schneider Electric Ind. SAS, Rueil-Malmaison (FR)

(21) Appl. No.: 10/844,588

(22) Filed: May 13, 2004

(30) Foreign Application Priority Data
May 14, 2003 (FR) 03 05789

(51) Int. Cl. H01R 9/22

(52) U.S. Cl. 439/894

(57) ABSTRACT

The invention relates to a conversational terminal whose body is flush with the front face of a base such as a panel or console.

A fastening element such as a frame 30, is joined to the body at the back of same by means of fixation blocks. A plurality of threaded spacers 40 having parallel axes are affixed to the support 20 by countersunk heads and are provided with nuts 46 for adjusting the position in depth of the terminal relative to the front face of the support.

Application in particular to industrial conversational terminals using in a polluting environment.

The present invention relates to a conversational terminal comprising, for its attachment to a flat support, a member for engaging in a base opening in such a fashion as to be flush with the front face of the base, and a means for adjustably fastening the member relative to the base.

This type of terminal is currently used in industrial installations for conversing with a machine or an automatic device. In general, the terminal is box-like, comprises an indicator or a screen and buttons and is enclosed in a rectangular opening in a panel, console or similar flat base. The encasing is done from the front and the body of the terminal is provided to this end with a rim that bears against the edge of the opening. In order to affix the terminal to the base, generally clamping means are utilized and used on the back side of the panel (see document EP 0 962 038).

At times, it has been found to be necessary to attach, on the front part of the base, an customization and/or protection foil, which provides the conversational area with a smooth appearance and makes it possible to cover the keys and possibly the display device. The foil shows appropriate information for the user and makes it possible to prevent various splashing or soiling of the conversational face of the terminal. The addition of such a customization and/or protection sheet assumes that the terminal does not extend beyond the front face of the base and is simply flush with said face. A first drawback to be overcome is thus in the necessity of precisely controlling the flush arrangement in order to prevent impairment of the visibility of the display and the tactile effect of the keys. A second difficulty to be overcome resides in the very substantially variable thickness of the order of 1.5 mm to 6 mm, for example, of the base.

The object of the invention is to provide a simple means of flush mounting of a conversational terminal relative to a flat base, said mounting involving considerable ease especially in positioning and removal, as well as in fine adjustment of the flush arrangement and adapting to the very substantially variable thicknesses of the base.

According to the invention, the adjustable fastening means comprise :

on the one hand a fastening frame fixedly mounted to the back of the body of the terminal and secured to it by means of fasteners, and

on the other hand, threaded spacer members axially perpendicular to the base, which have heads mounted in the base and supported at the end towards the back against the edges of the base openings; further, the threaded spacer members are secured to the base prior to assembly of the frame, traversing flanges of the frame and co-operating with nuts for controlling the position of the flanges and accordingly the depth positioning of the frame—body assembly relative to the front surface of the base.

The fastener member is preferably a frame, harness or similar rigid flanging member joined to the body of the terminal by means of quick-fastening blocks, the fastening blocks being arranged in immovable fashion between one wing of the frame parallel to the flanges and a latching element provided on or in the body.

The body of the terminal can be in a box-like in shape and provided on the front with a lip accommodated in the contour of the opening of the base, while the fixation frame associated with the body has a strip adapted to the contour of the body and at least one edge for bearing towards the front against the lip of the body.

Preferably, the threaded spacers each have a thin head that is countersunk in a counterbore provided in the front face of the base or which, when there is a thickness compensation plate applied to the front of the base, is countersunk in a hole in the plate. The spacers are advantageously rotationally immobilized relative to the base, but they can also be optionally replaced by screws or bolts screwed into the support or bolts welded to the support.

The features and advantages of the invention will become apparent in the following detailed description of an embodiment with reference to the appended drawings.

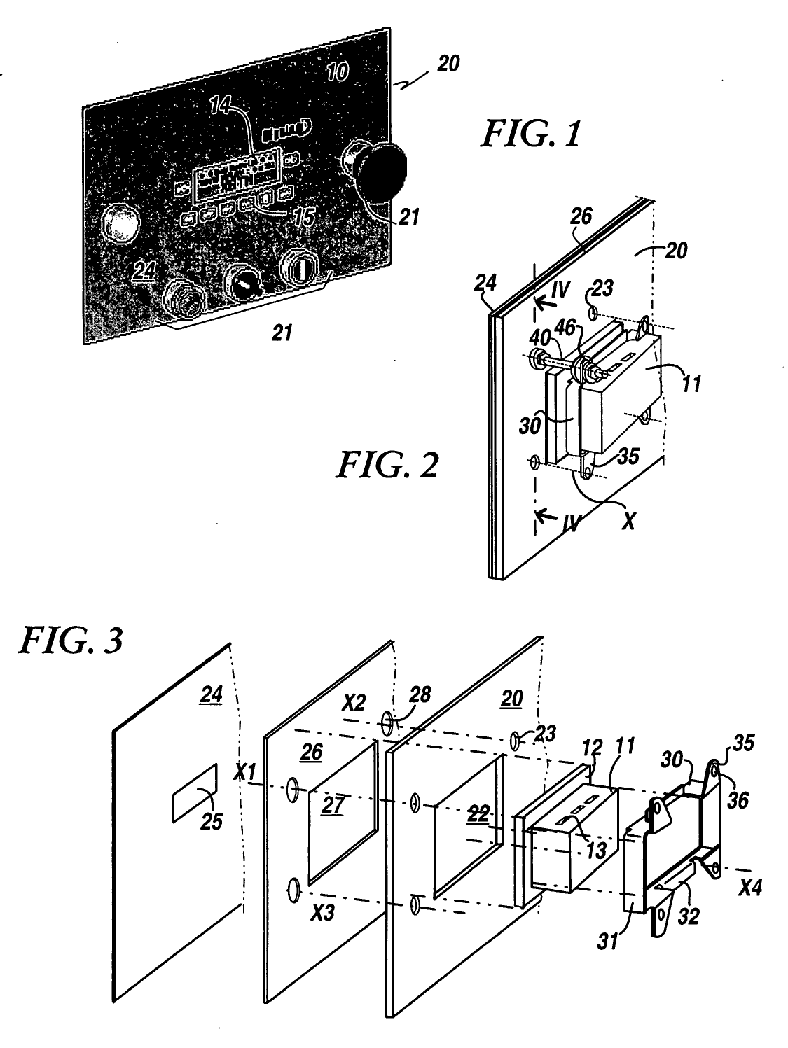

FIG. 1 represents a perspective view of the front of an industrial terminal flush mounted in protected fashion, flush with the front face of a base such as a console;

FIG. 2 represents a perspective rear view of the terminal;

FIG. 3 represents a view similar to FIG. 2, showing an exploded view of the terminal and its mounting means;

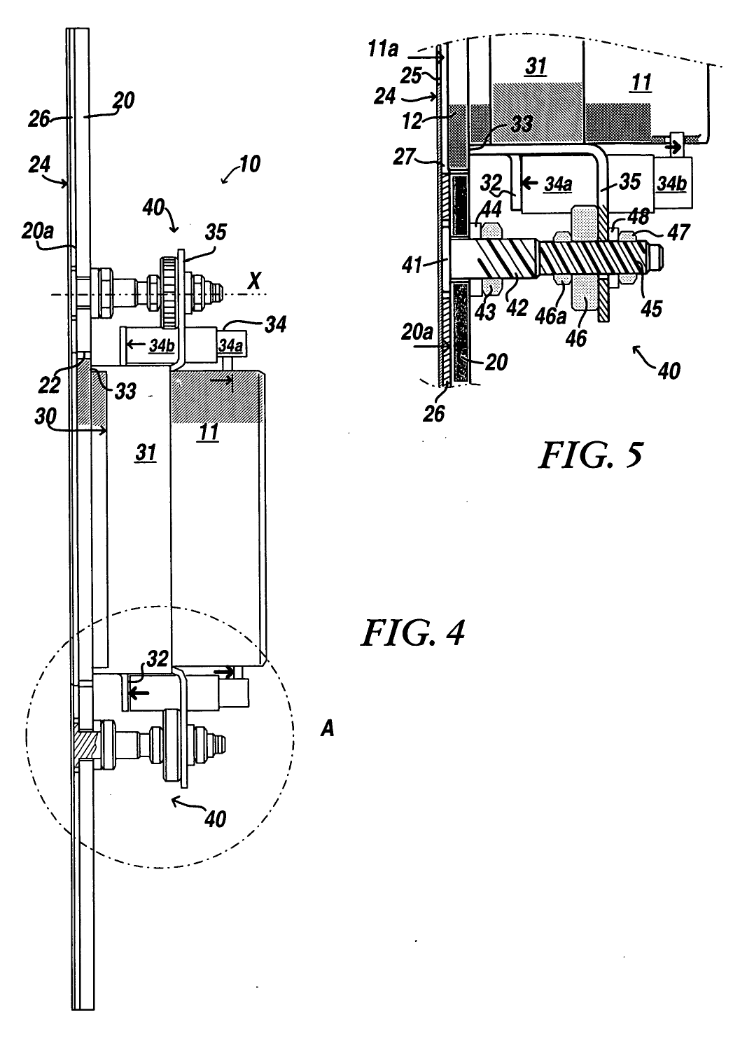

FIG. 4 represents a side view in cross-section along the plane IV-IV of FIG. 2;

FIG. 5 represents the detail A of FIG. 4 in larger scale;

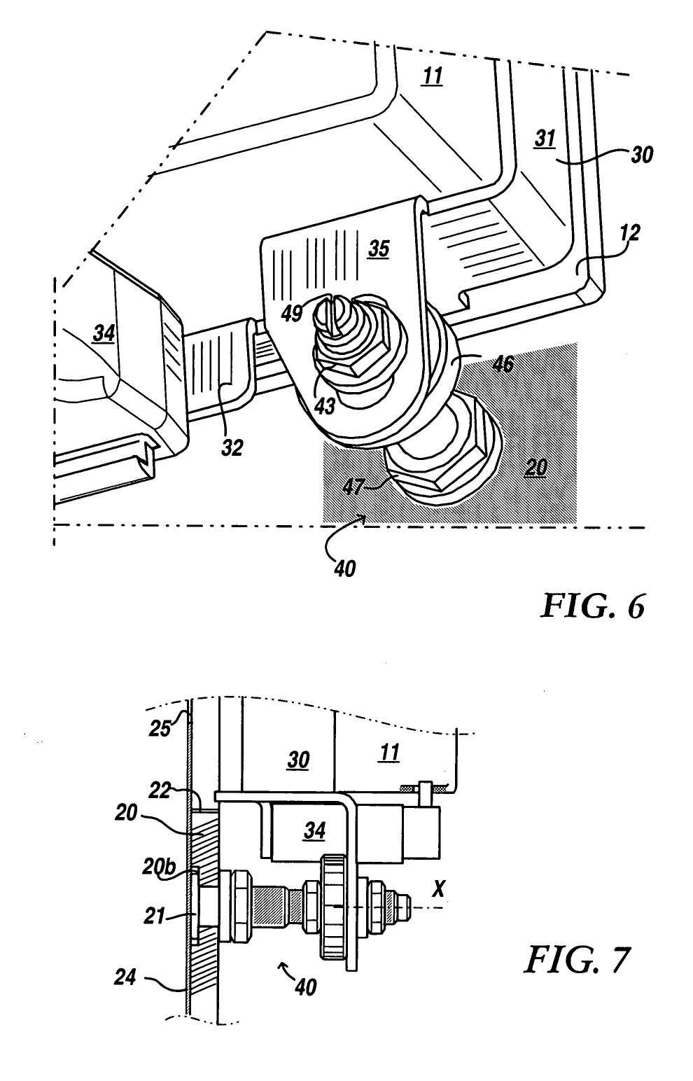

FIG. 6 represents an enlarged perspective rear view of detail A;

FIG. 7 represents in similar fashion to FIG. 5 an alternative mounting of the terminal.

The terminal represented in the figures is an industrial conversational terminal 10 having a body 11 and mounted on a flat base 20 such as a panel, a console or a flat area by means of a fixation member 30 such as a frame, harness, flange or other similar element that can be applied to the body for retaining it. The fastening element 30 is fixedly joined to the back of the body 11. Said body is substantially box-like and is provided with a mounting rim 12 towards the front. Over at least two sides, the horizontal sides, for example, the terminal has latching openings 13 whose role will be explained below. Towards the front, the body of the terminal has a front face 11a provided with a display or a screen 14 (see FIG. 1) and, alongside this, dialogue buttons 15, the front face of the body being flush with the front face 20a of the base (see FIG. 5). It should be noted that the lip 12, usually provided for immobilizing against the periphery in front of a rectangular opening 22 of the base 20, engaging here only in said opening 22 in fitting fashion (here rectangular) without being supported against its edges. The front and back sides of the terminal are designed as such as a function of the normal conversational position of the operator.

Furthermore, the support 20 is provided with other conversational elements 21 such as START/STOP, switching, emergency stop, etc. push-buttons. In order to pass the fixation spacers that will be described below, the support 20 has four openings 23 arranged near the corners of the rectangular opening 22, the axes of said openings X1-X4 being parallel to the direction transverse to the plane of the base.

The user covers the base 20 with a protective and customization foil 24. This foil can partially cover the base, but preferably it tightly covers it by leaving—as represented in FIG. 3—a transparent inspection window 25 on the face of the single display 14. The foil 24 has, in addition, passages for the conversational elements 21.

In a first embodiment, adapted to the thin bases, a compensation plate 26 (see FIGS. 2 and 3) is intercalated between the base 20 and the protection foil 24. The plate 26 has an mounting opening 27 dimensioned as the opening 22 and holes 28 coaxial to the hole 23. In a second embodiment (see FIG. 7), adapted to the thicker bases, there is no compensation plate.

The threaded spacers 40 having parallel axes X1-X4 are arranged for affixing, in adjustable fashion as to depth, the terminal to the back of the base 20. The spacers 40 are three or four in number and are rotationally immobilized. They can also be bolts welded to the base or crimped onto the support or even metal inserts or even screws fixed by bolts to the base.

The rigid frame 30 is made of any suitable material, is present in the form of a strip 31 having a form adapted to the standard contour of the body and provide with two lips, wings or similar vertical support elements 32 and stop edges 33. The vertical edges 32 co-operate in the mounted condition with the respective blocks 34 for assuring the rapid fixation of the frame to the body 11 by elastic clamping. The edges of the stop 33 bear against back side of the lip 12 of the body 11 of the terminal. These blocks function, for example, by cam effect or buttressing, in this latter case, they can conform to those described in the EP 0 962 038. The frame 30 is provided with fixation flanges 35, deflected at a right angle relative to the strip and forming tabs which extend beyond at the height of the body contour. The flanges are equal in number to that of the spacers and are provided with pass-through holes 36 for the spacers. It follows that the frame can be immobilized over the body of the terminal by other immovable fastening means.

In the embodiment represented, the spacers 40 each has a countersunk flat head 41. The head 41 engages, depending on the situation, in a counterbore 20b formed in the front face of the base 20 or in the hole 28 of the compensation plate 26. In the first instance, the countersunk head 41 has a thickness less than that of the support 20. In the second instance, the countersunk head 41 has a thickness equal to or less than that of the compensation plate 26. The spacer has a first threaded part 42 for carrying a fastening nut 43 to the base, having a washer 44, a second threaded part 45 defining the distance of adjustment and intended to carry an adjusting nut 46, having a locking counternut, as well as a frame fastening nut 47 with a washer 48. The first threaded part has a diameter greater than that of the second threaded part. The free end 49 of the spacer 40, situated at the back, is split.

FIG. 7 represents the case explained above where, the base 20 having a thickness sufficient for accommodating the flat head 41 of the spacer, the intercalating compensation plate 26 is eliminated and the flat head is accommodated in the countersunk 20b.

The terminal represented in the figures is mounted in the following fashion. It is assumed that the openings and holes are cut in advance in the base 20 and the compensation plate 26 (when the latter is provided). The frame 30 is slid against the body 11 of the terminal up to the stop of its edges 33 against the back face of the lips 12 of the body 11; the locking blocks 34 are engaged in the openings 13 of the body, then actuated in order to be put in a buttressing position as described in the EP 0 962 038. It will be recalled that their part 34a is then applied against a support element 32 of the frame and that a protrusion of its part 34b is applied against the edge of the respective opening 13 of the body. The frame 30 is then joined with the body 11.

The spacers 40 are then engaged in the holes 23 of the base 20 and their flat heads 41 countersunk into the holes 28 of the intercalating compensation plate 26 (FIGS. 2 to 5) or in the countersinks 20a of the base (FIG. 7). The nuts 43 are engaged with the washers 44 on the first threaded part 42, then the nuts 43 are locked in order to fix the spacers 40 relative to the base 20 and/or the plate 26. The nut of the stop 46 is then engaged with the counternut on the second threaded part 45. The assembly formed by the terminal 10 and the frame 30 is positioned on the spacers 40 by engagement of the flanges with their holes 36 on the spacers. The adjustment of the position of the terminal 10 relative to the base 20 is obtained by adjustment of the stop nut 46 over the length of the second threading 45 and immobilization of the nut 46 by means of an immobilization means 46a such as a counternut, in such a way that the front face of the terminal 10 is flush with the front face 20a of the base (or the plate 26), then the terminal is immobilized in the desired position by locking the nuts 47.

The protective foil 24 can then be applied to the front of the support or to the compensation plate.

The terminal is thus easy to assemble and dismantle on the variable thickness of the flat bases and it will be noted in particular that, when the terminal is changed, the mounting position is maintained by the adjusting nuts 46.

1. A conversational terminal comprising a body for accommodating in an opening of a flat support (20), in such a way as to be flush with a front face (20a) of the base and comprising the back side of the base of the adjustable fixation means of the body relative to the base,
characterized in that:
the adjustable fastening means comprise
on the one hand a fastening frame (30) fixedly mounted to the back of the body (11) of the terminal and secured to it by means of fasteners, and
on the other hand, threaded spacers (40) having axes perpendicular to the base, which have heads (41) mounted within the support (20) and receiving stop support towards the back against the edges of support holes (23),
the threaded spacers (40) are joined to the base (20) prior to assembly of the frame (30), traversing flanges (35) of the frame and co-operating with the nuts in order to control the position of the flanges and thus the positioning in depth of the frame (30)—body (11) assembly relative to the front face (20a) of the base.

2. The terminal according to claim 1, wherein a box-like body (11) provided at the front with a lip (12) housed in the contour of the opening (22) of the base, the frame (30) having a strip (31) adapted to the contour of the body of the terminal and at least one stop edge (33) towards the front against the flange (12) of the body.

3. The terminal according to claim 1, wherein the threaded spacers (40) each have a thin countersunk head (41) in a recess (20b) provided in the front face of the base (20).

4. The terminal according to claim 1, wherein the threaded spacers (40) each have a thin head (41) countersunk into a hole (28) of a compensation plate (26) applied to the front of the base (20), the head (41) being supported towards the back against an edge of the hole (23) of the base (20).

5. The terminal according to claim 1, wherein the fastening elements (34) are quick-fastening blocks, said blocks being arranged immovably between a wing (32) of the frame parallel to the flanges (35) and a latching element (13) provided on or in the body.

6. The terminal according to claim 1, characterized in that the threaded spacers (40) have a first threaded part (42) for assuring their direct fixation by nut to the base (20) and a second threaded part (45) defining the adjustment distance of the frame (30)—body (11) assembly, the diameter of the first part being greater than that of the second part.
